(19) United States
(12) Patent Application Publication
(10) Pub. No.: US 2002/0112961 A1
(43) Pub. Date: Aug. 22, 2002

(54) Multi-layer microfluidic device fabrication

(75) Inventors: Stephen D. O'Connor, Pasadena, CA (US); Marci Pezzuto, Altadena, CA (US); Eugene Dantsker, Sierra Madre, CA (US)

Correspondence Address: LYON & LYON LLP, 633 WEST FIFTH STREET, SUITE 4700, LOS ANGELES, CA, 90071, US

(73) Assignee: Nanostream, Inc.

(21) Appl. No.: 10/125,292

(22) Filed: Apr. 17, 2002

Related U.S. Application Data
(63) Continuation-in-part of application No. 09/453,029, filed on Dec. 2, 1999.

(51) Int. Cl. B01L 3/00

(52) U.S. Cl. 204/601; 422/100

(57) ABSTRACT

Multi-layer microfluidic devices with convoluted channels and densely positioned microfluidic structures are provided. Desirable microfluidic structures which, if cut in a single device layer, would be subject to deformation, may be created from multiple, non-deforming layers. Channel segments of any geometry defined in separate layers communicate to form continuous flow paths that in turn form the desirable microfluidic structures. Any number of device layers may be used to fabricate the microfluidic structures as desired.

### STATEMENT OF RELATED APPLICATION(S)

This application is filed as a continuation-in-part of U.S. patent application Ser. No. 09/453,029, filed Dec. 2, 1999 and currently pending.

### FIELD OF THE INVENTION

The present invention relates to the fabrication of multi-layer microfluidic devices.

### BACKGROUND OF THE INVENTION

There has been a growing interest in the application of microfluidic systems to a variety of technical areas, including such diverse fields as biochemical analysis, medical diagnostics, chemical synthesis, and environmental monitoring. For example, use of microfluidic systems for acquiring chemical and biological information presents certain advantages. In particular, microfluidic systems permit complicated processes to be carried out using very small volumes of fluid. In addition to minimizing sample volume, microfluidic systems increase the response time of reactions and reduce reagent consumption. Furthermore, when conducted in microfluidic volumes, a large number of complicated biochemical reactions and/or processes may be carried out in a small area, such as in a single integrated device. Examples of desirable applications for microfluidic technology include analytical chemistry; chemical and biological synthesis; DNA amplification; and screening of chemical and biological agents for activity, among others.

One technique for fabricating microfluidic devices uses stencil layers or sheets to define channels and/or other microfluidic structures. For example, a computer-controlled plotter modified to accept a cutting blade may be used to cut various patterns through a material layer. Such a blade may be used either to cut sections to be detached and removed from the stencil layer or to fashion slits that separate certain regions of a layer without removing any material. Other methods that may be employed to form stencil layers include conventional stamping or die-cutting technologies or laser cutting. The above-mentioned methods for cutting through a stencil layer or sheet permit robust devices to be fabricated quickly and inexpensively.

After a portion of a stencil layer is cut or removed, the outlines of the cut or otherwise removed portions form the lateral boundaries of microfluidic structures that are completed upon sandwiching the stencil between other device layers, such as substrates and/or other stencils. The thickness or height of the microfluidic structures such as channels or chambers may be varied by altering the thickness of the stencil layer, or by using multiple substantially identical stencil layers stacked on top of one another. When assembled in a microfluidic device, the top and bottom surfaces of stencil layers are intended to mate with one or more adjacent device layers (such as stencil layers and/or substrate layers) to form a substantially enclosed device, typically having at least one inlet port and at least one outlet port.

Certain microfluidic operations require relatively lengthy channels to allow, for example, diffusion mixing of samples and reagents, particles to settle out of suspension, remixing of particles into suspension and/or separation of sample components. However, one of the principal advantages of microfluidic devices is the ability to perform multiple and/or repetitive operations results in very complex microfluidic structures within the device in a small area. Thus, in order to accommodate these lengthy channels in the small area of the microfluidic device, the channels must be compressed by convoluting them. Additionally, if multiple operations are to be performed in a single microfluidic device, the fluids flowing serially between these operations often must loop around or “U-turn” in the device. Also, performance of some operations, such as serial or parallel dilutions, metering, and/or introducing additional fluids into a fluid stream, may require the use of multiple structures positioned in close proximity.

For example, PCT Application No. WO 99/60397 to Holl, et al., entitled Liquid Analysis Cartridge (the “Holl Application”), discloses several variations of lengthy convoluted storage and diffusion mixing channels (see Holl Application, FIGS. 1A, 2A-2B, 3A-3D). PCT Application No. WO 99/19717 to Bjornson, et al., entitled “Laminate Microstructure Device and Method for Making Same” (the “Bjornson Application”) discloses several variations of lengthy and convoluted separation channels (see Bjornson Application, FIGS. 3A-3C, 4).

One characteristic of these dense and convoluted microfluidic structures is the presence of “peninsulas,” that is, features defined by and circumscribed by the channel structure (hereinafter “circumscribed features”). For example, FIGS. 1A-B, which illustrate devices 510A, 510B with convoluted paths similar to those disclosed in the Holl Application, show numerous circumscribed features 512A, 512B defined by the convolutions of the channels 514A, 514B. Likewise, FIGS.1C-1E, which illustrate devices 510C, 510D, 510E with channel structures similar to those disclosed in the Bjornson Application, show numerous circumscribed features 512C, 512D, 512E defined by the channels 514C, 514D, 514E. In another example, FIG. 1F illustrates a channel structure 510F in which a channel 514F and chambers 516F define circumscribed features 512F. Such a structure might be used to meter preset volumes of a given fluid, introduce reagents into a sample fluid stream, or perform serial or parallel dilutions of a sample.

When channels are cut completely through the channel-bearing layer of a microfluidic device, such as a stencil layer in a stencil-based device, the presence of such circumscribed features may interfere with the fabrication of the device. This is because an unsupported circumscribed feature defined in a single stencil layer may act as a loose “flap” when the stencil layer is being positioned and affixed to another layer or substrates. For example, the circumscribed feature may fold, twist, skew, or otherwise deform during assembly, potentially resulting in defects in the assembled microfluidic structure.

FIGS. 2A-2E show a microfluidic structure 519 comprising a stencil layer 520 through which a channel 522 has been cut, thus defining a circumscribed feature 524. It should be understood that the structure 519 illustrated in FIGS. 2A-2E is simplified for ease of illustrating the fabrication process and potential defects that may arise during the fabrication process. Similar or even more extensive and severe defects may occur in the more complex structures illustrated above or in complex structures that might be used in other microfluidic devices.

Referring to FIG. 2B, when the stencil layer 520 is positioned over a device layer 526 (which may be another stencil layer or a substrate), the circumscribed feature 524 may deform downward towards the device layer 526. Gravity, momentum, air currents, or other forces arising in the assembly process may cause this deformation. Thus, the edge 532 of the circumscribed feature 524 may contact the device layer 526 before the entirety of the stencil layer 520 is brought into contact with the device layer 526. A first ghost line 528 illustrates the desired position of the circumscribed feature 524 relative to the device layer 526 in an assembled device. Another ghost line 530 shows where the edge 532 of the circumscribed feature 524 first contacts the surface of the device layer 526 as it is lowered onto the device layer 526. As the stencil layer 529 and the device layer 526 are brought together, any force between the device layer 526 and the edge 532 may cause the circumscribed feature 524 to deform. Such forces may arise from friction or bonding due to the presence of an adhesive on the stencil layer 520 (including the circumscribed feature 524) and/or the device layer 526.

The deformation may result in a skewing of the circumscribed feature 524, as illustrated in FIGS. 2C and 2D. This skewing may result in a complete closure of a portion of the channel 522 as shown in FIG. 2C at region 525. Such a closure could render the final device 519 inoperative or inaccurate. Alternatively, the skewing may result in a partial closure of the channel 522, as shown in FIG. 2D at region 527. Such a partial closure could induce undesirable impedance in the flow of fluids through the channel 522, thereby affecting the performance of the microfluidic device 519. Also, such a partial closure could affect the volume of the channel 522, thus potentially affecting the accuracy of measurements performed with the microfluidic device. The deformation also could fold or wrinkle the circumscribed feature 524, 10 as shown in FIG. 2E. The wrinkle 534 could cause leakage between two portions of the channel 522. This leakage could affect the performance of the microfluidic device by shortening the travel path for at least some portion of the fluid. Also, the wrinkle 534 could affect the volume of the channel 522, thus potentially affecting the accuracy of the microfluidic device. Of course, some or all of these defect modes could occur simultaneously in one or more portions of a microfluidic device.

In light of the foregoing, there exists a need for multi-layer microfluidic devices incorporating channels that define circumscribed features that may be fabricated without appreciable deformation of circumscribed features during assembly of the device.

### SUMMARY OF THE INVENTION

As is further discussed in the detailed description, multi-layer microfluidic devices according to different embodiments may be constructed in various different materials and in various geometries or layouts. Various embodiments are directed to fabrication of deformable circumscribed features in a microfluidic structure.

In a first separate aspect of the invention, a microfluidic channel network comprises a plurality of device layers each having a characteristic thickness. A first channel segment and a second channel segment each are defined through the entire thickness of different device layers and an overlap region permits fluid communication between the first channel segment and a second channel segment. Fluid conducted within the fluid flow path experiences a directional change substantially greater than about ninety degrees.

In another separate aspect of the invention, a microfluidic device for conducting a fluid comprises a first device layer having a characteristic thickness and a second device layer having a characteristic thickness. A first channel segment is defined through the entire thickness of the first device layer and a second channel segment defined through the entire thickness of the second device layer. An overlap region permits fluid communication between the first channel segment and the second channel segment. At least a portion of the first channel segment conducts fluid in a first direction, at least a portion of the second channel segment conducts fluid in a second direction, and the first direction and the second direction differ by substantially greater than about ninety degrees.

In another separate aspect of the invention, a microfluidic device comprises a first device layer having a characteristic thickness and a second device layer having a characteristic thickness. A first channel segment is defined through the entire thickness of the first device layer and a second channel segment is defined through the entire thickness of the second device layer. An overlap region permitting fluid communication between the first channel segment and the second channel segment such that the first channel segment and second channel segment define a continuous flow path that defines a directional change substantially greater than ninety degrees.

In another separate aspect of the invention, a microfluidic device comprises a first device layer having a characteristic thickness and a second device layer having a characteristic thickness. A first channel segment is defined through the entire thickness of the first device layer and a second channel segment is defined through the entire thickness of the second device layer. The second channel is in fluid communication with the first channel segment to form a continuous flow path that defines a deformable circumscribed feature.

In another separate aspect of the invention, a microfluidic device for conducting a fluid comprises a first device layer having a characteristic thickness and a second device layer having a characteristic thickness. A first channel segment defines a non-deformable circumscribed feature through the entire thickness of the first device layer. A second channel segment defines a non-deformable circumscribed feature through the entire thickness of the second device layer. An overlap region permits fluid communication between the first channel segment and the second channel segment. The first channel segment and the second channel segment define a deformable circumscribed feature having a feature length and an aspect ratio.

In another separate aspect of the invention, a microfluidic device for conducting a fluid comprises a first device layer having a characteristic thickness, a second device layer having a characteristic thickness, and a third device layer having a characteristic thickness. A first channel segment defines a non-deformable circumscribed feature through the entire thickness of the first device layer. A second channel segment defines a non-deformable circumscribed feature through the entire thickness of the second device layer. A third channel segment defines a non-deformable circumscribed feature through the entire thickness of the third device layer. A first overlap region permits fluid communication between the first channel segment and the second channel segment. A second overlap region permits fluid communication between the second channel segment and the third channel segment. The first channel segment, the second channel segment and the third channel segment define a deformable circumscribed feature having a feature length and an aspect ratio.

In another separate aspect of the invention, a microfluidic device for conducting a fluid comprises a first device layer having a characteristic thickness, a second device layer having a characteristic thickness, and a third device layer having a characteristic thickness. A first channel segment defines a non-deformable circumscribed feature through the entire thickness of the first device layer. A second channel segment defines a non-deformable circumscribed feature through the entire thickness of the second device layer. A third channel segment defines a non-deformable circumscribed feature through the entire thickness of the first device layer. A first overlap region permits fluid communication between the first channel segment and the second channel segment and a second overlap region permits fluid communication between the second channel segment and the third channel segment. The first channel segment, the second channel segment and the third channel segment define a deformable circumscribed feature having a feature length and an aspect ratio.

In another separate aspect of the invention, a microfluidic device comprises a first device layer having a characteristic thickness and a second device layer having a characteristic thickness. A first plurality of channel segments defines a first plurality of non-deformable circumscribed features through the entire thickness of the first device layer. A second plurality of channel segments defines a second plurality of non-deformable circumscribed features through the entire thickness of the second device layer. The first plurality of channels are in fluid communication with the second plurality of channels to form at least one continuous flow path that defines at least one deformable circumscribed feature having a feature length and an aspect ratio.

In another separate aspect of the invention, a microfluidic device comprises a plurality of device layers each having a characteristic thickness. A plurality of channel segments each define a non-deformable circumscribed feature through the entire thickness of at least one of the plurality of device layers. Each of the plurality of channel segments are in fluid communication at least one other of the plurality of channel segments to form at least one continuous flow path defining at least one deformable circumscribed feature having a feature length and an aspect ratio.

In a further aspect of the invention, any of the foregoing separate aspects may be combined for additional advantage.

These and other aspects and objects of the invention will be apparent to one skilled in the art upon review of the following detailed disclosure, drawings, and claims.

### BRIEF DESCRIPTION OF THE DRAWINGS

FIG. 1A is a top schematic view of a first illustrative convoluted channel structure of a microfluidic device.

FIG. 1B is a top view of a second illustrative convoluted channel structure of a microfluidic device.

FIG. 1C is a top view of a third illustrative convoluted channel structure of a microfluidic device.

FIG. 1D is a top view of a fourth illustrative convoluted channel structure of a microfluidic device.

FIG. 1E is a top view of a fifth illustrative convoluted channel structure of a microfluidic device.

FIG. 1F is a top view of a sixth illustrative convoluted channel structure of a microfluidic device.

FIG. 2A is a top view of a microfluidic device layer having a circumscribed feature.

FIG. 2B is perspective view of the device layer of FIG. 2A during affixation to another device layer.

FIG. 2C is a top view of the assembled device layers of FIG. 2B, showing a first illustrative failure mode.

FIG. 2D is a top view of the assembled device layers of FIG. 2B, showing a second illustrative failure mode.

FIG. 2E is a perspective view of the assembled device layers of FIG. 2B, showing a third illustrative failure mode.

FIG. 3A is a top view of a first illustrative microfluidic channel structure.

FIG. 3B is a top view of a second illustrative microfluidic channel structure.

FIG. 3C is a top view of a third illustrative microfluidic channel structure.

FIG. 3D is a top view of a fourth illustrative microfluidic channel structure. FIG. 3D′ is a graphical representation of a method for calculating the angular change in flow direction of the structure of FIG. 3D.

FIG. 3E is a top view of a fifth illustrative microfluidic channel structure.

FIG. 4A is a top view of a typical microfluidic channel defining a circumscribed feature and a flow path.

FIG. 4B is a top view of two device layers for fabricating a first structure according to the present invention providing a flow path equivalent to that shown in FIG. 4A. FIG. 4B′ is a top view of the assembled layers of FIG. 4B.

FIG. 4C is a top view of two device layers for fabricating a second structure according to the present invention providing a flow path equivalent to that shown in FIG. 4A.

FIG. 4C′ is a top view of the assembled layers of FIG. 4C.

FIG. 4D is a top view of three device layers for fabricating a third structure according to the present invention providing a flow path equivalent to that shown in FIG. 4A.

FIG. 4D′ is a top view of the assembled layers of FIG. 4D.

FIG. 4E is a top view of three device layers for fabricating a fourth structure providing a flow path equivalent to that shown in FIG. 4A. FIG. 4E′ is a top view of the assembled layers of FIG. 4E.

FIG. 5A illustrates components of a microfluidic device according to the present invention constructed with 18 stencil layers each shown in top view.

FIGS. 5B-5C are top view photomicrographs of two stages of operation of a microfluidic device assembled with the layers shown in FIG. 5A with water passing through the device.

FIG. 6A illustrates components of a microfluidic device according to the present invention constructed with 9 stencil layers each shown in top view.

FIGS. 6B-6C are top view photomicrographs of two stages of operation of a microfluidic device assembled with the layers shown in FIG. 6A with water passing through the device.

FIG. 7A is a top view of one or more superimposed device layers defining channel segments useful for fabricating a microfluidic device according to the present invention.

FIG. 7B is a top view of one or more superimposed device layers defining channel segments useful for fabricating a microfluidic device according to the present invention.

FIG. 7C is a top view of at least a portion of a microfluidic device having an equivalent flow path to the superimposed layers of FIGS. 7A-7B, the device having a microfluidic channel structure defining a circumscribed feature.

### DETAILED DESCRIPTION OF PREFERRED EMBODIMENTS OF THE INVENTION

Definitions

The term “appreciable deformation” as used herein refers to any deformation that exceeds the applicable defect or dimensional tolerance for the device.

The term “circumscribed feature” as used herein refers to any portion of a continuous flow path defining a feature base, a feature length, and an aspect ratio. The feature base is a line between a beginning point of the portion of the continuous flow path and an end point of the portion of the continuous flow path. If the continuous flow path passes between the beginning and end points, as occurs when the continuous flow path is a spiral, then the feature base is a line drawn between the beginning point and the nearest point on the intervening portion of the continuous flow path. The feature length is the distance from the feature base to the feature tip measured along the shortest line between the two points that does not cross any void in the device layer. The feature tip is the point on the circumscribed feature that is furthest from the feature base without crossing a void in the device layer. The aspect ratio of a circumscribed feature is the feature length divided by the length of the feature base.

The term “channel” as used herein is to be interpreted in a broad sense. Thus, the term “channel” is not intended to be restricted to elongated configurations where the transverse or longitudinal dimension greatly exceeds the diameter or cross-sectional dimension. Rather, the term is meant to include a conduit of any desired shape or configuration through which liquids may be directed. A channel may be filled with one or more materials.

The term “deformable circumscribed feature” as used herein refers to a circumscribed feature where, if the circumscribed feature were defined on a single device layer, then the base would be too small, the length would be too long, and/or the aspect ratio would be too high to permit the device to be assembled without appreciable deformation of the feature during the assembly process.

The term “cumulative flow angle change” as used herein refers to the cumulative change of direction of the fluid flow along the portion of a continuous flow path defining a circumscribed feature. The change in direction may be defined by any combination of distinct corners and/or gradual curves.

The term “major dimension” as used herein refers to the largest of the length, width, or height of a particular shape or structure. For example, the major dimension of a circle is its radius, and the major dimension of a rectangle (having a length that is greater than its width or height) is its length. As applied to an aperture, the major dimension of a circular aperture is its radius, and the major dimension of a typical rectangle is its length.

The term “microfluidic” as used herein is to be understood, without any restriction thereto, to refer to structures or devices through which fluid(s) are capable of being passed or directed, wherein one or more of the dimensions is less than 500 microns.

The term “non-deformable circumscribed feature” as used herein refers to a circumscribed feature defined on a single device layer where the base is sufficiently long, the length is sufficiently short and/or the aspect ratio is sufficiently low to permit the device to be assembled without appreciable deformation.

The term “overlap region” as used herein refers to a zone wherein fluid communication between two or more fluid streams is established, preferably wherein at least one channel extends over or past, or covers, a portion of another channel.

The terms “passive mixing” as used herein refer to mixing between fluid streams in the absence of turbulent flow conditions and without the use of moving elements.

The term “stencil” as used herein refers to a material layer or sheet that is preferably substantially planar, through which one or more variously shaped and oriented channels have been cut or otherwise removed through the entire thickness of the layer, thus permitting substantial fluid movement within the layer (as opposed to simple through-holes or vias that transmit fluid through one layer to another layer). The outlines of the cut or otherwise removed portions form the lateral boundaries of microfluidic structures that are completed when a stencil is sandwiched between other layers, such as substrates and/or other stencils. Stencil layers can be flexible, thus permitting one or more layers to be manipulated so as not to lie in a plane.

The term “substantially sealed” as used herein refers to a microstructure having a sufficiently low unintended leakage rate and/or volume under given flow, fluid identity, and pressure conditions. The term also encompasses microfluidic structures that have one or more fluidic ports or apertures to provide fluid inlet or outlet utility.

Fabrication of Microfluidic Structures

Microfluidic devices according to the present invention are constructed using stencil layers or sheets to define channels for transporting fluids.

In a preferred embodiment, a microfluidic device is provided comprising first and second substrates, and at least one stencil disposed (e.g., sandwiched) between the first and second substrates so as to define one or more sealed microfluidic structures therebetween. The stencil may be adhered to at least one of the first and second substrates by an adhesive or thermal bonding. In a preferred embodiment, there is a plurality of sandwiched stencils. Preferably, the first and second substrates are substantially planar, and have surfaces complementary with each other so as to better seal microfluidic structures therebetween. The first and second substrates preferably are made from Mylar®, FR-4, polyester, glass, acrylic, polycarbonate or fiberglass.

Adhesive for use with stencil-based devices may be rubber-based, acrylic-based, or a gum-based. In a preferred embodiment, the stencil is self-adhesive. In a most preferred embodiment, the stencil comprises an adhesive tape, which can be single-sided (i.e., have adhesive on one side) or double-sided (i.e., have adhesive on both sides). Any adhesive tape may be used, including especially commercially available adhesive tapes. Examples of types of adhesive tape include, but are not limited to, pressure-sensitive tapes, temperature-activated (e.g., heat activated) tapes, chemically-activated (e.g., two-part epoxy) tapes and optically-activated (e.g., UV-activated) tapes. Preferably, the adhesive tape comprises a backing material selected from the group consisting of Mylar® nylon and polyester, to support the adhesive. In an alternate embodiment, the stencil and at least one of the first and second substrates are ultrasonically welded together. In another alternate embodiment, the stencil(s) and substrates may be thermally bonded.

The stencil can be made from polymers, papers, fabrics and foils, among other materials. Preferably, the stencil comprises a polymer selected from the group consisting of Mylar® polyesters, polyimides, vinyls, acrylics, polycarbonates, Teflon® Kapton® polyurethanes, polyethylenes, polypropylenes, polyvinylidene fluorides, polytetrafluoroethylenes, nylons, polyethersulfones acetal copolymers polyesterimides, polysulfones, polyphenylsulfones, ABS polyvinylidene fluorides, polyphenylene oxides, and derivatives thereof. In one preferred embodiment, the stencil comprises a fluorinated polymer, which are known to be chemically resistant. The stencil may be made from an elastomeric material, such as, for example, rubber, viton, or silicone.

A microfluidic device of the present invention preferably further comprises a sealant coat on at least a portion of one or more of the stencil, the first substrate and the second substrate. The sealant coat can help adhere the substrates and the stencil(s) together, and help seal the microstructure(s) defined therebetween. The sealant coat preferably comprises a silicone material. Alternatively, the sealant coat can comprise one or more of Teflon®, Avatre®, Liquin® fluorocarbons, fluorothermoplastics, polyvinylidene fluorides, acrylics, waxes, epoxies, solders, polymers, paints, oils, and varnishes. The sealant coat can be applied by a number of different methods, including spin-deposition, spraying and dipping.

The microfluidic device preferably includes one or more microfluidic structures comprising one or more channels and/or or chambers. In certain applications, the microfluidic structure is at least partially filled with a filling material, such as a filter material. The filter material may comprise a wide variety of materials capable of specific and non-specific filtering of various size parameters. Any of various chemical, biological and size-exclusion filter materials may be used. In certain embodiments, the filter material is selected from the group consisting of polycarbonates, acrylics, acrylamides, polyurethanes, polyethylenes, polypropylenes, polyvinylidene fluorides, polytetrafluoroethylenes, naphion, nylons, and polyethersulfones. The filter material may also be selected from the group consisting of agarose, alginate, starch, and carrageenan. Preferably, the filter material is Sephadex®, Sephacil®, or hydroxyapatite. In a preferred embodiment, the filling material is applied by silk screening, which can reduce the manufacturing time and cost.

The filling material can also be applied using lithography. Preferably, the filling material is applied using pick-and-place techniques, which are well known in the semiconductor manufacturing industries.

The microfluidic device can be used to divide a liquid sample into a plurality of samples. In one embodiment, such splitting of samples is accomplished by using a microstructure comprising one or more forked channels, each preferably having one or more constrictions to control fluid flow therethrough.

Microfluidic devices according to the present invention may be produced by various methods. One method comprises the steps of (a) providing a first substrate; (b) layering on the first substrate one or more panels, each comprising an array of stencils; and (c) layering on the one or more panels a second substrate so as to define a plurality of microfluidic structures therebetween. Preferably, at least one of the first and second substrates has one or more apertures. Also, it is preferred that at least one of the panels is aligned with at least one of the first and second substrates so that the apertures are in fluid communication with the microfluidic structures. Such alignment is preferably provided by peg-and-hole alignment. The present invention also provides in certain embodiments microfluidic devices prepared according to the foregoing method.

A stencil layer is preferably substantially planar and has one or more microfluidic structures such as channels cut through the entire thickness of the layer. For example, a computer-controlled plotter modified to manipulate a cutting blade may be used. Such a blade may be used either to cut sections to be detached and removed from the stencil layer, or to fashion slits that separate regions in the stencil layer without removing any material. Alternatively, a computer-controlled laser cutter may be used to cut patterns through the entire thickness of a material layer. While laser cutting may be used to yield precisely dimensioned microfluidic structures, the use of a laser to cut a stencil layer inherently removes some material. Further examples of methods that may be employed to form stencil layers include conventional stamping or die-cutting technologies. Any of the above-mentioned methods for cutting through a stencil layer or sheet permits robust devices to be fabricated quickly and inexpensively compared to conventional surface micromachining or material deposition techniques used by others to produce microfluidic structures.

After a portion of a stencil layer is cut or removed, the outlines of the cut or otherwise removed portions form the lateral boundaries of microfluidic structures that are completed upon sandwiching a stencil between substrates and/or other stencils. Upon stacking or sandwiching the device layers together, the upper and lower boundaries of a microfluidic channel within a stencil layer are formed from the bottom and top, respectively, of adjacent stencil or substrate layers. The thickness or height of microfluidic structures such as channels can be varied by altering the thickness of a stencil layer, or by using multiple substantially identical stencil layers stacked on top of one another. When assembled in a microfluidic device, the top and bottom surfaces of stencil layers are intended to mate with one or more adjacent stencil or substrate layers to form a substantially sealed device, typically having one or more fluid inlet ports and one or more fluid outlet ports. A stencil layer and surrounding stencil or substrate layers may be bonded using any appropriate technique.

The wide variety of materials that may be used to fabricate microfluidic devices using sandwiched stencil layers include polymeric, metallic, and/or composite materials, to name a few. In especially preferred embodiments, however, polymeric materials are used due to their inertness and ease of manufacture.

When assembled in a microfluidic device, the top and bottom surfaces of stencil layers may mate with one or more adjacent stencil or substrate layers to form a substantially sealed device, typically having one or more inlet and/or outlet ports. In one embodiment, one or more layers of a device may be fabricated from single- or double-sided adhesive tape, although other methods of adhering stencil layers may be used. A portion of the tape (of the desired shape and dimensions) can be cut and removed to form microfluidic structures such as channels. A tape stencil can then be placed on a supporting substrate with an appropriate cover layer, between layers of tape, or between layers of other materials. In one embodiment, stencil layers can be stacked on each other. In this embodiment, the thickness or height of the channels within a particular stencil layer can be varied by varying the thickness of the stencil layer (e.g., the tape carrier and the adhesive material thereon) or by using multiple substantially identical stencil layers stacked on top of one another.

Various types of tape may be used with such an embodiment. Suitable tape carrier materials include but are not limited to polyesters, polycarbonates, polytetrafluoroethlyenes, polypropylenes, and polyimides. Such tapes may have various methods of curing, including curing by pressure, temperature, or chemical or optical interaction.

The thickness of these carrier materials and adhesives may be varied. As an alternative to using tape, an adhesive layer may be applied directly to a non-adhesive stencil or surrounding layer. Examples of adhesives that might be used, either in standalone form or incorporated into self-adhesive tape, include rubber-based adhesives, acrylic-based adhesives, gum-based adhesives, and various other types.

Notably, stencil-based fabrication methods enable very rapid fabrication of robust microfluidic devices, both for prototyping and for high-volume production. Rapid prototyping is invaluable for trying and optimizing new device designs, since designs may be quickly implemented, tested, and (if necessary) modified and further tested to achieve a desired result. The ability to prototype devices quickly with stencil fabrication methods also permits many different variants of a particular design to be tested and evaluated concurrently.

In addition to the use of adhesives or single- or double-sided tape discussed above, other techniques may be used to attach one or more of the various layers of microfluidic devices useful with the present invention, as would be recognized by one of ordinary skill in attaching materials. For example, attachment techniques including thermal, chemical, or light-activated bonding; mechanical attachment (including the use of clamps or screws to apply pressure to the layers); or other equivalent coupling methods may be used.

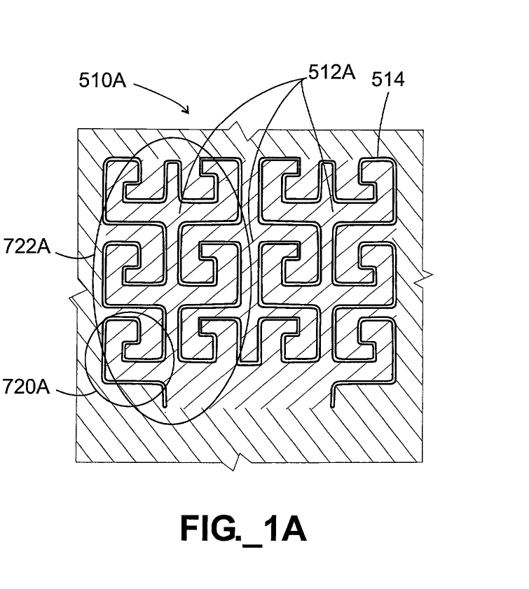

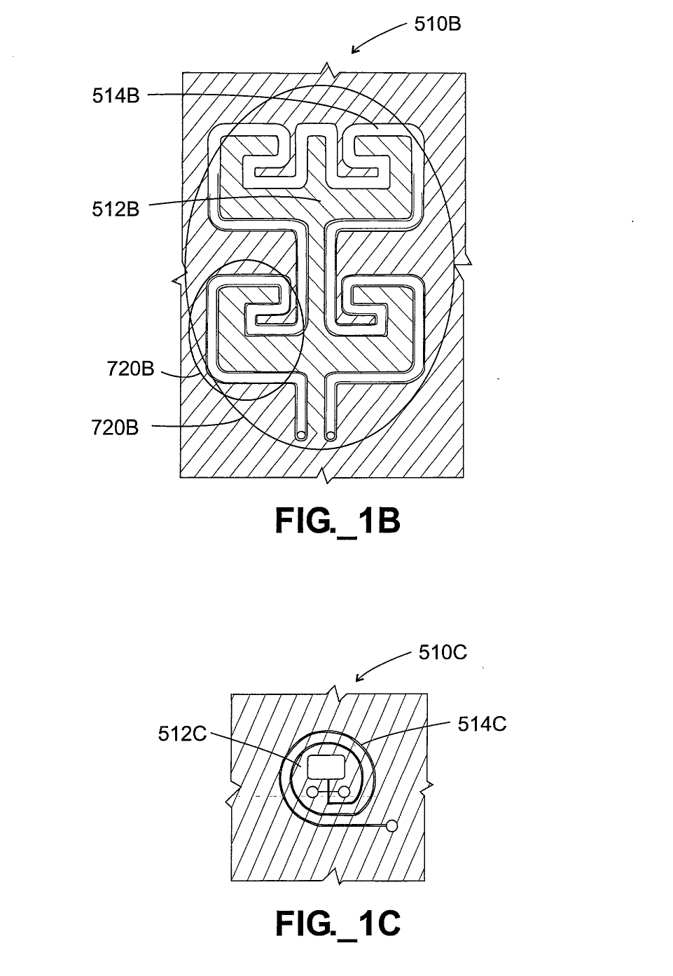

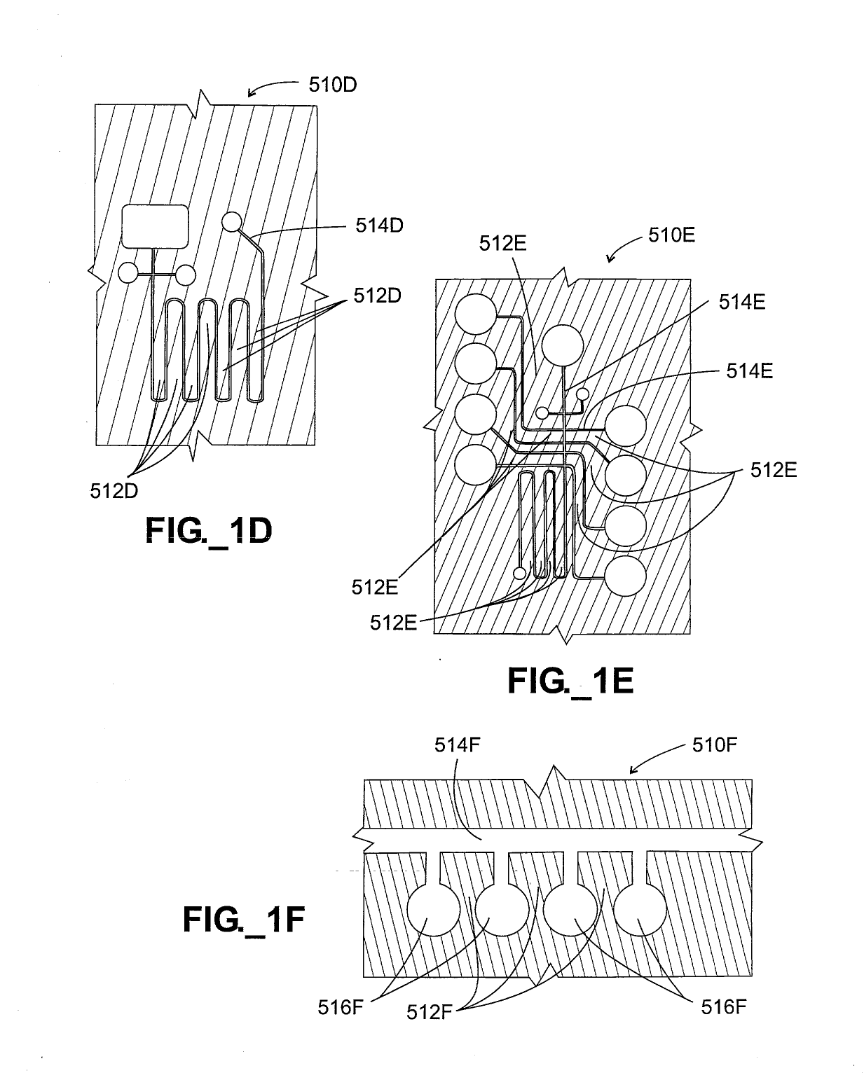

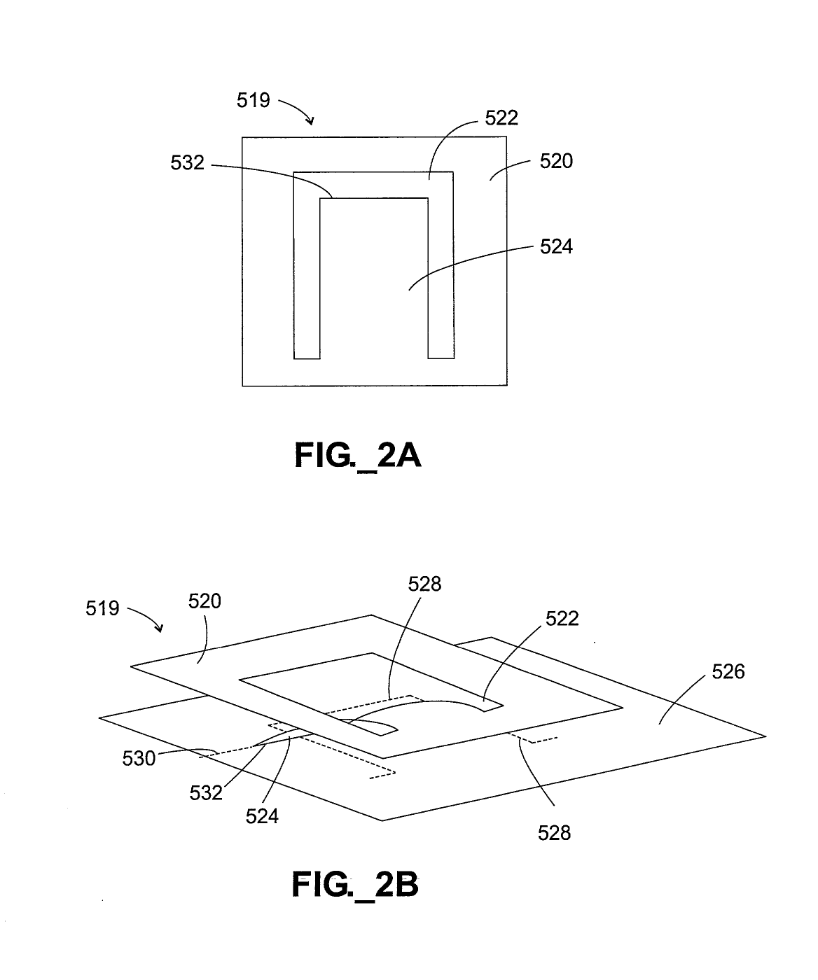

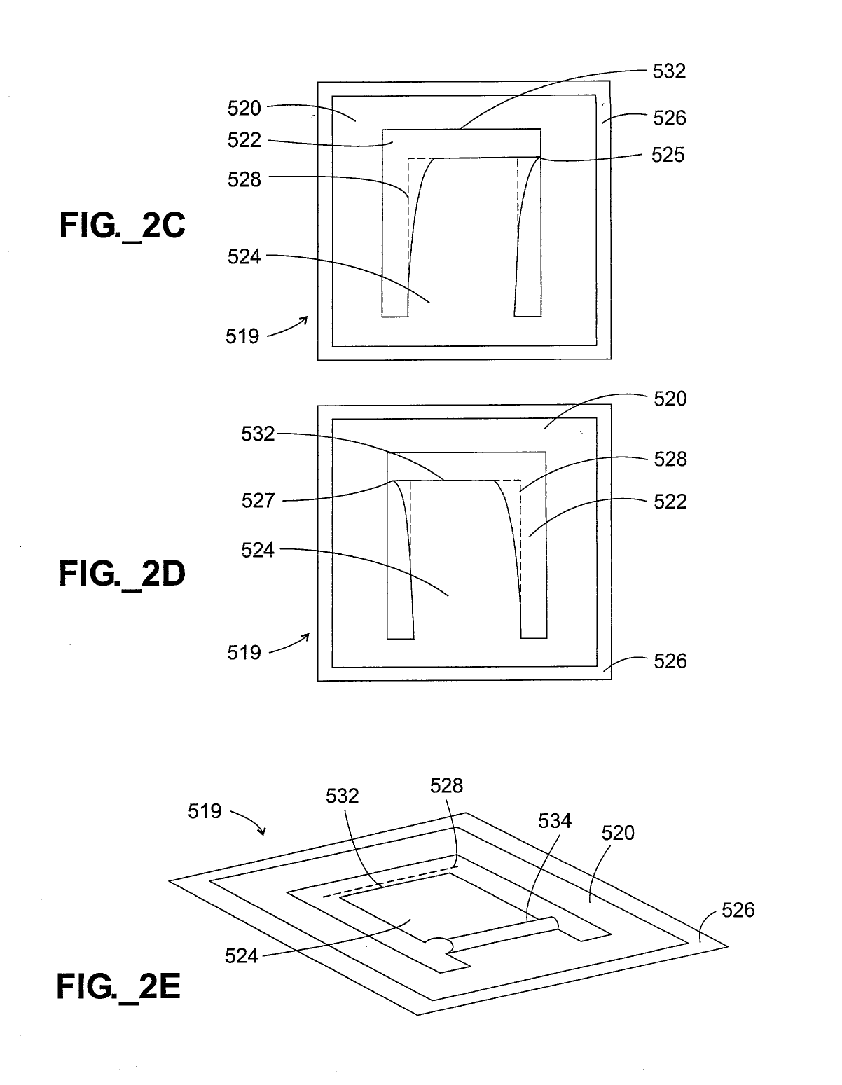

As discussed above in connection with FIGS. 1A-1F and 2A-2E, certain desirable structures in microfluidic devices, such as convoluted channels and repetitive arrays, may define deformable circumscribed features, i.e., features that, if defined in a single layer, are likely to deform during the manufacturing processes discussed above.

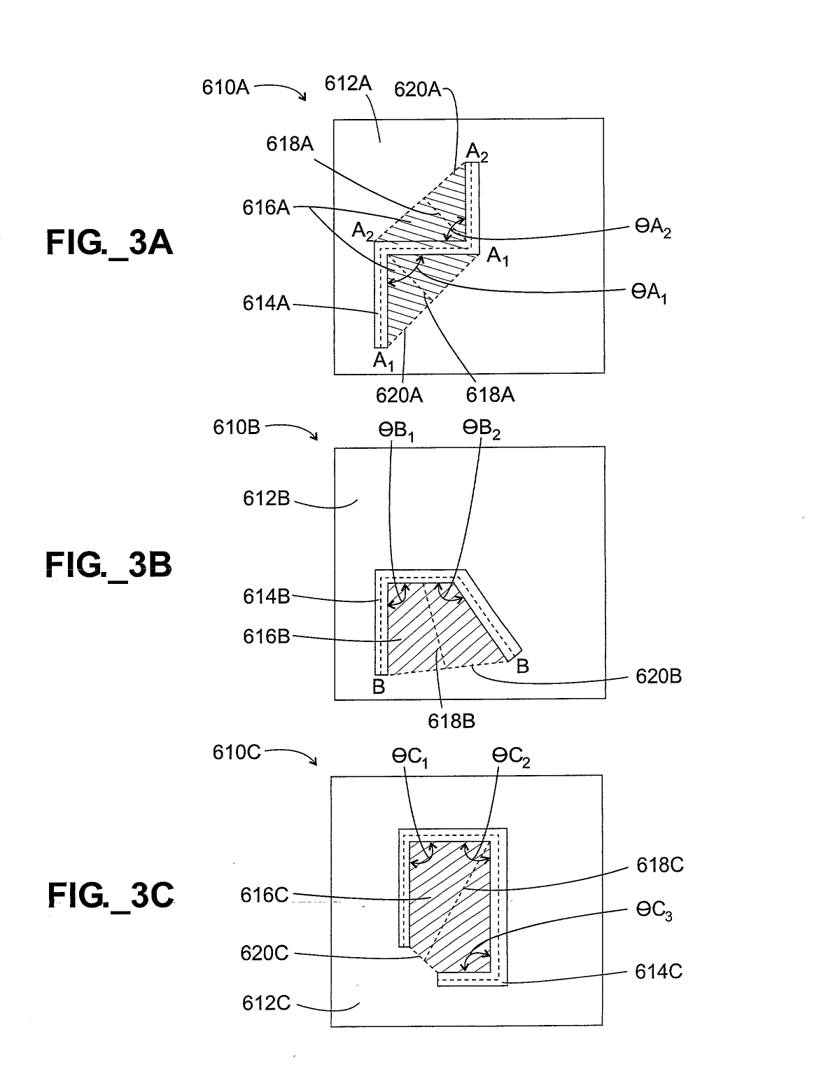

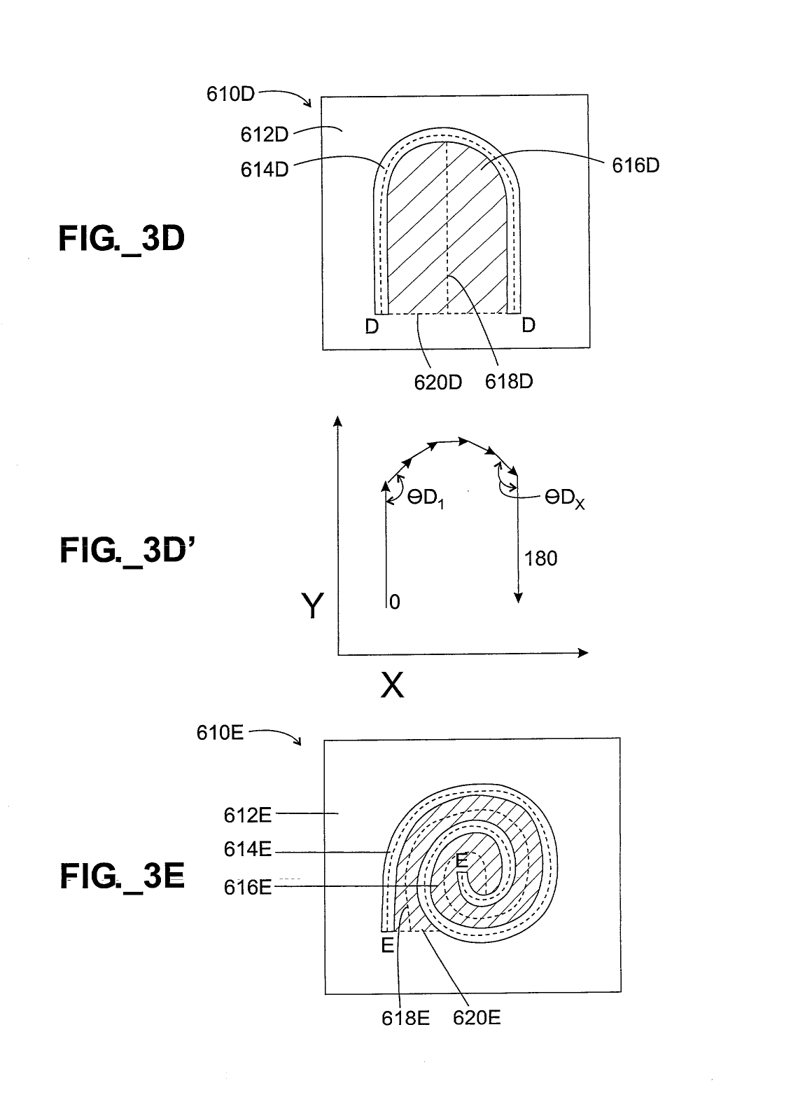

Circumscribed features may be created by a number of different geometric patterns defined by a fluid channel, as illustrated in FIGS. 3A-3E. For example, in FIG. 3A, a device layer 610A comprises a planar material 612A with a channel 614A defined through the entire thickness of the material 612A. The channel 614A defines a continuous flow path that may be characterized as two continuous flow path portions “A₁”-“A₁” and “A₂”-“A₂.” The channel 614A changes direction twice along its length, forming angles ΘA₁ and ΘA₂, each having a magnitude of about ninety degrees. The channel 614A defines two circumscribed features 616A (shaded for illustrative purposes). The circumscribed features 61 6A are characterized by a feature base 620A, and a feature length 618A.

In FIG. 3B, a device layer 610B comprises a planar material 612B with a channel 614B defined the entire thickness of the material 612B. The channel 614B defines a continuous flow path “B”-“B.” The channel 614B changes direction twice along its length, forming angle ΘB₁ having a magnitude of about ninety degrees and angle ΘB₂ having a magnitude of about forty-five degrees. The channel 614B defines a circumscribed feature 616B (shaded for illustrative purposes). The circumscribed feature 616B is characterized by a feature base 620B, and a feature length 618B.

In FIG. 3C, a device layer 610C comprises a planar material 612C with a channel 614C defined the entire thickness of the material 612C. The channel 614C defines a continuous flow path “C”-“C.” The channel 614C changes direction three times along its length, forming angles ΘC₁, ΘC₂ and ΘC₃, each having a magnitude of about ninety degrees. The channel 614C defines a circumscribed feature 616C (shaded for illustrative purposes). The circumscribed feature 616C is characterized by a feature base 620C, and a feature length 618C.

Of course, circumscribed features may be defined by curved channels as well.

In FIG. 3D, a device layer 610D comprises a planar material 612D with a channel 614D defined 30 the entire thickness of the material 612D. The channel 614D defines a continuous flow path “D”-“D.” The channel 614D curves along its length. The cumulative angular change in the direction of the flow path is about one hundred eighty degrees. Referring to FIG. 3D′, because a curve forms no distinct angle, one may treat the curved portion as being made up of a number of short straight segments forming angles ΘD₁,through ΘDₓ, and summing the magnitude of each to arrive at a total angular change. The channel 614D defines a circumscribed feature 616D (shaded for illustrative purposes). The circumscribed feature 616D is characterized by a feature base 620D, and a feature length 618D.

Other feature geometries also may be formed. For example, FIG. 3E, illustrates a device layer 610E comprises a planar material 612E with a spiral channel 614E defined the entire thickness of the material 612E. The channel 614E defines a continuous flow path “E”-“E.” The channel 614E curves along its length. The cumulative angular change in the direction of the flow path is about seven hundred and twenty degrees (which may be determined applying the method described above with reference to FIGS. 3D and 3D′). The channel 614E defines a circumscribed feature 61 6E (shaded for illustrative purposes). The circumscribed feature 616E is characterized by a feature base 620E, and a feature length 618E.

Any of these geometric patterns may be used repeatedly and in combination in a single microfluidic device. Likewise, the specific geometric features of each pattern may be altered and combined, for instance, angles exchanged for curves and vice versa. Regardless of the combination of geometric features and patterns found in a microfluidic structure, any time a circumscribed feature is present, it is desirable to determine whether this feature is likely to deform during fabrication of the device and whether the degree of deformation is likely to induce defects in the assembled device (i.e., exceed the dimensional or defect tolerance of the device). It should be understood that some deformation of the device layers and/or features defined therein might result in defects that do not affect the accuracy or performance of the device. The degree to which a particular device can tolerate deformation is dependent on the design and function of that device and can readily be determined by one skilled in the art.

Whether a circumscribed feature is likely to suffer appreciable deformation (i.e., deformations resulting in defects outside the acceptable tolerance range as determined by one skilled in the art) during device assembly depends on one or more of the following factors: length of the feature base, feature length, aspect ratio, proximity of multiple features, and physical properties of the material of the device layer.

As discussed above, the stencil layers of a microfluidic device may be made from a variety of materials. The thickness of each layer may be selected so that channels cut through the stencil layers have the desired volume, based on the channel height and width. The thickness of each layer affects the structural behavior of the layer and features defined therein. For example, of two layers made of the same material, but each having a different thickness, the thicker layer generally will be more stiff or rigid.

] Thus, it would appear to be desirable to use the thickest possible layer material, because to do so would result in a stiff stencil where any circumscribed features would be unlikely to deform. However, in order to maintain the very small channel volumes required to provide the laminar flow and low fluid volumes that characterize microfluidic structures, channels cut in a thicker device layer will necessarily be narrower than channels cut in a thinner device layer. While it is possible to cut very narrow channels, using, for instance, etching processes developed for the semiconductor industry, the time to fabricate and complexity of these processes may be very high.

Moreover, a wide variety of stencil materials are readily available in thickness ranging from about twenty-five microns to about five hundred microns. For these thicknesses, a typical microfluidic channel may be as wide as two millimeters while still maintaining desirable microfluidic properties. Channels of this width may be cut quickly and simply using certain techniques described herein, such as by using a laser cutter, a plotter modified to manipulate a cutting blade, or a cutting die.

Many of these readily available stencil materials are characterized by high elasticity and flexibility. Consequently, it has been found that circumscribed features exhibiting certain characteristic geometries and/or dimensions may be susceptible to deformation during the assembly process. For example, circumscribed features with a short feature base, such as the features shown in FIGS. 3A-3E, may deform because the feature base 620A-E may not be sufficiently long to support the circumscribed feature 616A-E. Likewise, the feature length 618A-E (and, thus, moment arm) may be so long that mass of the circumscribed feature 616A-E or even very small forces could cause significant deformation of the circumscribed feature 616A-E during assembly of the device.

The relationship between feature base length and feature length also is significant. Circumscribed features with a short feature base length and a long feature length may be more susceptible to deformation. Thus, the aspect ratio, i.e., feature length divided by feature base length, may indicate potential problems.

Repetitive structures also may result in feature deformations. For example, some microfluidic structures include repetitive densely packed features, such as the saw-tooth channels shown in FIG. 3A, which are formed by successive ninety-degree angles in a channel.

While one “tooth” of this structure may be, by itself, structurally stable, it has been found that long runs of such teeth may allow the edges of the device layer on either side of the channel to flex independently, resulting in uneven channel width and other defects. Similar deformation may occur with other repetitive structures, metering arrays, trunk/channel structures, or other closely spaced features in fluid communication.

The likelihood that a given circumscribed feature will deform may be determined by calculating the rigidity of the feature based on its material properties and dimensions. Such calculations are well understood in the art. It has been empirically determined, however, that adherence to certain design rules obviates the need for calculating the deformation of each specific feature.

First, it is important to identify the entire feature circumscribed by a continuous flow path. For instance, referring to FIGS. 1A and 1B, circumscribed features 720A, 720B may be identified within the structure. Even though a calculation may determine that these circumscribed features are non-deformable, an examination of the entire structure reveals that the circumscribed features 720A, 720B are portions of larger circumscribed features 722A, 722B. Given the very high aspect ratio of these structures (exacerbated in FIG. 1A by the presence of repetitive, adjacent circumscribed features), it is likely that these features would deform substantially during assembly.

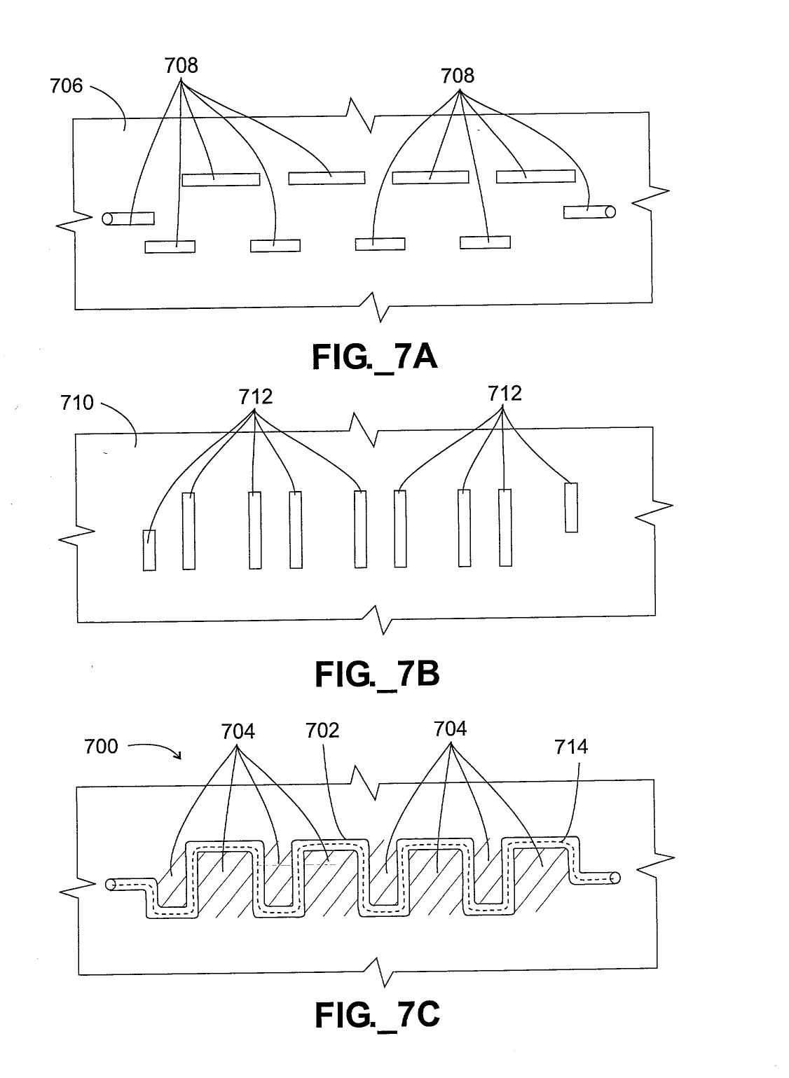

Typically, a deformable circumscribed feature arises when a continuous flow path experiences an absolute directional change substantially greater than ninety degrees. Absolute directional changes greater than about one hundred eighty degrees are particularly problematic. These directional changes may occur in one structural feature, such as a “U-turn” or as the result of several adjacent structures. For this reason, it may be necessary to determine the cumulative flow angle change, i.e., the sum of the angles of all the directional changes along a given continuous flow path. This is particularly true when a continuous flow path of interest has no absolute directional change, i.e., the fluid exits the continuous flow path in the same direction it entered, but encounters convolutions in the intermediate portion, such as in the structure shown in FIG. 7C.

For typical device layer materials having a thickness in the range of about twenty-five microns to about five hundred microns, it has been found that there is an increased risk of deformation if circumscribed features on a single device layer have a base feature length of less than or equal to about thirteen millimeters, a feature length greater than or equal to about six millimeters and/or an aspect ratio greater than or equal to about one. The risk of deformation has been found to increase substantially if circumscribed features on a single device layer have a base feature length of less than or equal to about six millimeters, a feature length greater than or equal to about thirteen millimeters and/or an aspect ratio greater than or equal to about one.

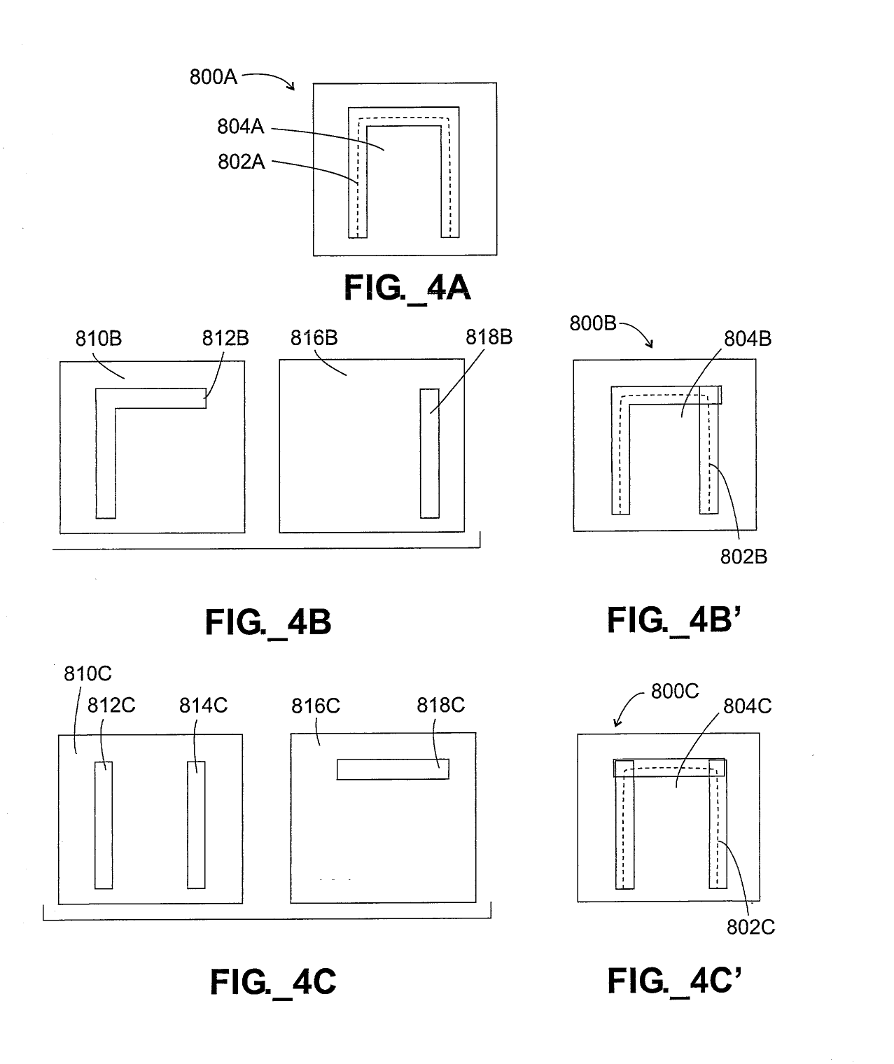

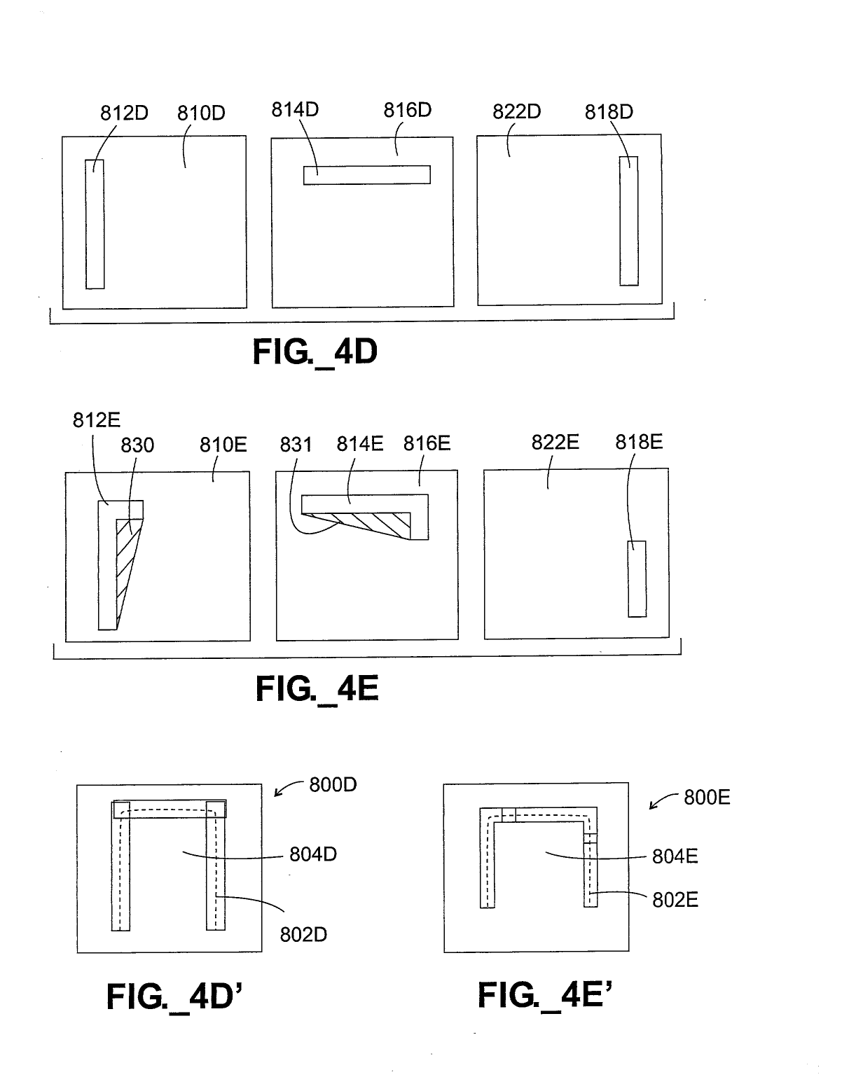

While adherence to the design rules described above will avoid the presence of deformable circumscribed features, these limitations may substantially limit the design of microfluidic structures in stencil devices. FIGS. 4A-4D illustrate a design and method for fabricating deformable circumscribed features in a microfluidic device by combining multiple non-deformable circumscribed features on multiple device layers. It should be understood that FIGS. 4A-4E′ and 7A-7C illustrate a simplified structure for the purposes of illustrating design and fabrication techniques in accordance with the present invention. These designs and techniques may be applied to other, more complex microfluidic structures.

FIG. 4A illustrates a desirable microfluidic structure 800A having a continuous flow path 802A, the structure 800A defining a circumscribed feature 804A. For the purposes of this illustration it shall be assumed that the dimensions and material properties of the structure 800A are such that the circumscribed feature 804A is a deformable circumscribed feature.

Thus, if the structure 800A were prepared in a single device layer, the deformable circumscribed feature 804A would be likely to deform when the device layer is affixed to another device layer.

FIGS. 4B-4E′ illustrate four approaches in accordance with embodiments of the present invention for fabricating microfluidic structures having flow paths equivalent to that defined by the structure 800A shown in FIG. 4A by assembling multiple device layers defining one or more non-deformable circumscribed features.

FIG. 4B shows a first device layer 810B, which defines a first channel segment 812B and a second device layer 81 6B defining a second channel segment 818B. The first device layer 810B is affixed to the second device layer 816B, forming device 800B, as shown in FIG. 4B′. Once the device 800B is assembled, the first channel segment 812B is in fluid communication with the second channel segment 818B, forming the continuous flow path 802B. The continuous flow path 802B defines the deformable circumscribed feature 804B; however, because no single layer defines a deformable circumscribed feature, there will be no stencil deformation when the layers are assembled. The continuous flow path 802B is equivalent to the continuous flow path 802A shown in FIG. 4A

FIG. 4C shows a first device layer 810C, which defines a first channel segment 812C and a second channel segment 814C. The first channel segment 812C and the second channel segment 814C are not in fluid communication. A second device layer 816C defines a third channel segment 818C. The first device layer 810C is affixed to the second device layer 816C, forming device 800C, as shown in FIG. 4C′. Once the device 800C is assembled, the first channel segment 812C and the second channel segment 814C are in fluid communication with the third channel segment 818C, forming the continuous flow path 802C. The continuous flow path 802C defines a deformable circumscribed feature 804C; however, because no single layer defines a deformable circumscribed feature, there will be no stencil deformation when the layers are assembled. Again, the continuous flow path 802C is equivalent to the continuous flow path 802A shown in FIG. 4A

FIG. 4D shows a first device layer 810D, which defines a first channel segment 812D. A second device layer 816D defines a second channel segment 814D. A third device layer 822D defines a third channel segment 818D. The first device layer 810D is affixed to the second device layer 816D so that the first channel segment 812D and the second channel segment 814D are in fluid communication. The third device layer 822D is affixed to the second device layer 816 so that the second channel segment 814D is in fluid communication with the third channel segment 818D, forming the device 800D, as shown in FIG. 4D′, with a continuous flow path 802D. The continuous flow path 802D defines the deformable circumscribed feature 804D; however, because no single layer defines a deformable circumscribed feature, there will be no stencil deformation when the layers are assembled. Once again, the continuous flow path 802D is equivalent to the continuous flow path 802A shown in FIG. 4A

The channel segments used to define a deformable circumscribed feature need not be straight segments. For example, FIG. 4E shows a first device layer 810E, which defines a first channel segment 812E. A second device layer 816E defines a second channel segment 814E. A third device layer 822E defines a third channel segment 818E. The first device layer 810E is affixed to the second device layer 816E so that the first channel segment 812E and the second channel segment 814E are in fluid communication. The third device layer 822E is affixed to the second device layer 816 so that the second channel segment 814E is in fluid communication with the third channel segment 818E, forming the device 800E with the continuous flow path 802E, as shown in FIG. 4E′. The continuous flow path 802E defines the deformable circumscribed feature 804E; however, because no single layer defines a deformable circumscribed feature, there will be no stencil deformation when the layers are assembled. The continuous flow path 802E is equivalent to the continuous flow path 802A shown in FIG. 4A

The channel segments 812E and 814E each define circumscribed features 830 (shaded for illustrative purposes). These circumscribed features 830 have a long base length, a short feature length and, hence, a low aspect ratio. Consequently, it is unlikely that these circumscribed features would deform during assembly of the device. Thus, it is possible to use multiple channels in multiple layers, each channel defining a non-deformable circumscribed feature and fluidly communicating to form a continuous fluid path to assemble a device defining a deformable feature. However, because no single layer defines a deformable circumscribed feature, there will be no stencil deformation when the layers are assembled. Of course, the channel segments need not be defined by straight segments, but may include curves or any combination of straight sections, angles and curves.

FIG. 7C illustrates a convoluted microfluidic structure 700 in accordance with the present invention. The microfluidic structure 700 comprises a channel 702 defining multiple circumscribed features 704. The circumscribed features 704 may be deformable due to their individual dimensions or as a consequence of the repetitive structure, as discussed above. In order to assemble the microfluidic structure 700 with a low likelihood of deformation, a first plurality of channel segments 708 are defined in a first device layer 706 and a second plurality of channel segments 712 are defined in a second device layer 710, as shown in FIGS. 7A-7B. Each of the channel segments 708, 712 making up the first and second pluralities of channel segments define non-deformable circumscribed features. In this case, the channel segments 708, 712 are straight segments; however, as discussed above with reference to FIGS. 4E and 4E′, the segments 708, 712 could also define curves, angles or any combination thereof, to define a non-deformable circumscribed feature.

The first device layer 706 is affixed to the second device layer 710 so that the first plurality of channel segments 708 are in fluid communication with the second plurality of channel segments 712 to form a continuous flow path 714. The continuous flow path 714 defines the deformable circumscribed features 704; however, because no single layer defines a deformable circumscribed feature, there will be no stencil deformation when the layers are assembled. Also, as discussed above with reference to FIG. 4D, more than two layers may be used to form microfluidic structure 700. For example, one or more of channel segments 708 could be defined in a third device layer (not shown), such that when the first second and third device layers are assembled, the channels 708, 712 and the channels (not shown) in the third layer (not shown) are in fluid communication to form continuous flow path 714.

In this manner, a desirable microfluidic structure which, if cut in a single device layer, would be subject to deformation, may be created from multiple, non-deforming layers. It will be readily understood by one skilled in the art that channel segments of any geometry may be used to form many different desirable microfluidic structures. Moreover, any number of device layers may be used to fabricate the microfluidic structures as desired.

### EXAMPLE 1

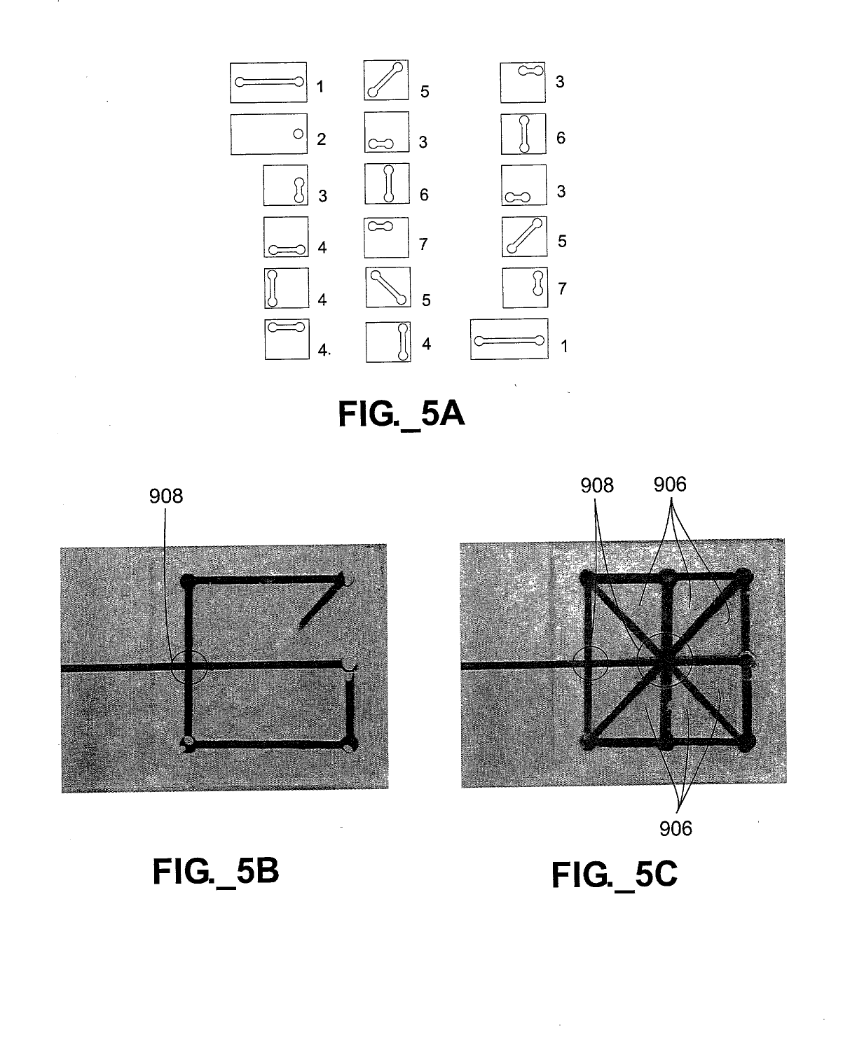

A three-dimensional microfluidic device was constructed as follows. Modular components were constructed by preparing stencils comprising channels by cutting a self-adhesive laminating sheet tape (Avery Dennison, LS10P, 73603) using a computer-controlled plotter modified to have a cutting blade. Seven of these modules were designed so that they could be reconfigured (using simple orientation changes) to construct various microfluidic devices. In this example, two different microfluidic devices were constructed using these modules. In both cases, the first stencil was placed on a 1/16″ thick polycarbonate sheet substrate having a drilled 33 mil hole as an inlet aperture. In one device, the remaining stencils were layered in the order shown in FIG. 5A (i.e., 1,2,3,4,4,4,5,3,6,7,5,4,3,6,3,5,7,1), so that fluid could pass from one layer to the next at specific locations designated by the round features.

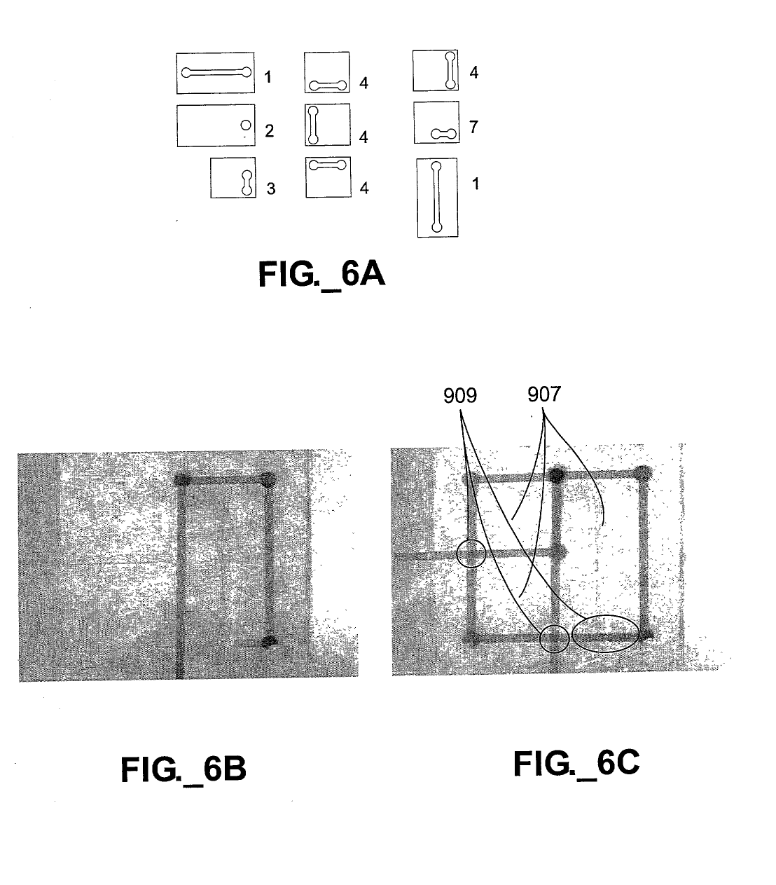

The final substrate was a piece of Avery Dennison LS1OP tape having an outlet aperture. In this 17-layer microfluidic device, fluid enters and exits from the same direction. FIGS. 5B-5C are photomicrographs of the device with colored acetonitrile passing therethrough at two stages of operation. An alternative device was constructed using five of the same modules, but by altering their layering order and orientation to be (1,2,3,4,4,4,4,7,1), as shown in FIG. 6A. FIGS. 6A-6B are photomicrographs of the device with colored water passing therethrough at two stages of operation. The devices shown in FIGS. 5A-5C and 6A-6B define deformable circumscribed features 906, 907, which are formed from multiple channel segments on multiple device layers in accordance with the present invention.

It should be noted that the microfluidic structures shown in FIGS. 5A-5C and 6A-6B include circumscribed features 906, 907 that are completely surrounded by channels the continuous flow path the channels define as well as crossover regions 908, 909, where channels cross over each other orhtogonally or in parallel. Completely surrounded circumscribed features formed on a single device layer would not just deform during assembly of the device, but would actually separate from the device layer, rendering such a structure difficult or impossible to maintain intact during assembly.

Likewise, channels that cross each other, either at an angle or in parallel, would be impossible in a single layer device without the fluids in each channel mixing with the other. Furthermore, such structures in a two layer device would allow fluid communication between crossing channel segments, because the segments are defined through the entire thickness of the device layer. Thus, non-communicating channel crossings may be made with three device layers, where one device layer is interposed between the crossing channels to prevent cross-communication of fluids in the crossover region. Both completely surrounded circumscribed features and crossed channel structures are fabricated may be fabricated accordance with the present invention, by assembling the structure from multiple device layers, as shown in FIGS. 5A and 6A,

The particular devices and construction methods illustrated and described herein are provided by way of example only, and are not intended to limit the scope of the invention. The scope of the invention should be restricted only in accordance with the appended claims and their equivalents.

What is claimed is:

1. A microfluidic channel network comprising:
a plurality of device layers each having a characteristic thickness;
a first channel segment and a second channel segment each defined through the entire thickness of different device layers; and
an overlap region permitting fluid communication between the first channel segment and a second channel segment;
wherein fluid conducted within the fluid flow path experiences a directional change substantially greater than about ninety degrees.

2. The microfluidic channel network of claim 1 wherein fluid conducted within the fluid flow path experiences a directional change of at least about one hundred eighty degrees.

3. The microfluidic channel network of claim 1 wherein the plurality of device layers includes at least one substantially non-rigid device layer.

4. The microfluidic channel network of claim 1 wherein the thickness of each device layer is substantially the same.

5. The microfluidic channel network of claim 1 wherein the thickness of each device layer is between about twenty-five microns and about five hundred microns.

6. The microfluidic channel network of claim 1 wherein the first channel segment and the second channel segment are defined in adjacent device layers.

7. A microfluidic device for conducting a fluid, the device comprising:
a first device layer having a characteristic thickness;
a second device layer having a characteristic thickness;
a first channel segment defined through the entire thickness of the first device layer;
a second channel segment defined through the entire thickness of the second device layer; and
an overlap region permitting fluid communication between the first channel segment and the second channel segment;
wherein at least a portion of the first channel segment conducts fluid in a first direction, at least a portion of the second channel segment conducts fluid in a second direction, and the first direction and the second direction differ by substantially greater than about ninety degrees.

8. The microfluidic device of claim 7 wherein the first direction and the second direction differ by at least about one hundred eighty degrees.

9. The microfluidic device of claim 7, further comprising a third channel segment defined through the entire thickness of a third device layer, wherein the third channel segment is in fluid communication with the second channel segment, at least a portion of the third channel segment conducts fluid in a third direction, and the first direction and the third direction differ by substantially greater than about ninety degrees.

10. The microfluidic device of claim 9 wherein the first direction and the third direction differ by at least about one hundred eighty degrees.

11. The microfluidic device of claim 7, further comprising a third channel segment defined through the entire thickness of the first device layer, wherein the third channel segment is in fluid communication with the second channel segment, at least a portion of the third channel segment conducts fluid in a third direction, and the first direction and the third direction differ by substantially greater than about ninety degrees.

12. The microfluidic device of claim 11 wherein the first direction and the third direction differ by at least about one hundred eighty degrees.

13. The microfluidic device of claim 7 wherein the thickness of each device layer is between about twenty-five microns and about five hundred microns.

14. The microfluidic device of claim 7 wherein the first device layer is adjacent to the second device layer.

15. The microfluidic device of claim 15 wherein the third device layer is adjacent to the second device layer.

16. The microfluidic device of claim 7 wherein each device layer of the plurality of device layers comprises a polymeric material.

17. The microfluidic device of claim 7 wherein any layer of the plurality of device layers is fabricated with self-adhesive tape.

18. A microfluidic device comprising:
a first device layer having a characteristic thickness;
a second device layer having a characteristic thickness;
a first channel segment defined through the entire thickness of the first device layer;
a second channel segment defined through the entire thickness of the second device layer; and
an overlap region permitting fluid communication between the first channel segment and the second channel segment such that the first channel segment and second channel segment define a continuous flow path;
wherein the continuous flow path defines a directional change substantially greater than about ninety degrees.

19. The microfluidic device of claim 18 wherein the continuous flow path defines a directional change of at least about one hundred eighty degrees.

20. The microfluidic device of claim 18 wherein the first device layer and the second device layer each have a thickness between about twenty-five microns and about five hundred microns.

21. The microfluidic device of claim 18 wherein the first device layer is adjacent to the second device layer.

22. The microfluidic device of claim 18 wherein the first device layer and the second device layer are fabricated with polymeric materials.

23. The microfluidic device of claim 18 wherein the first device layer or the second device layer are fabricated with self-adhesive tape.

24. The microfluidic device of claim 18, further comprising:
a third channel segment defined through the entire thickness the first device layer; and
a second overlap region permitting fluid communication between the second channel segment and the third channel segment such that the continuous flow path includes the third channel segment;
wherein the continuous flow path defines a directional change substantially greater than about ninety degrees.

25. The microfluidic device of claim 24 wherein the continuous flow path defines a directional change of at least about one hundred eighty degrees.

26. The microfluidic device of claim 24 wherein the first device layer and the second device layer each have a thickness between about twenty-five microns and about five hundred microns.

27. The microfluidic device of claim 24 wherein the first device layer is adjacent to the second device layer.

28. The microfluidic device of claim 18, further comprising:
a third channel segment defined through the entire thickness a third device layer; and
a second overlap region permitting fluid communication between the second channel segment and the third channel segment such that the continuous flow path includes the third channel segment;
wherein the continuous flow path defines a directional change substantially greater than about ninety degrees.

29. The microfluidic device of claim 28 wherein the continuous flow path defines a directional change of at least about one hundred eighty degrees.

30. The microfluidic device of claim 28 wherein the first device layer, the second device layer, and the third device layer each have a thickness between about twenty-five microns and about five hundred microns.

31. The microfluidic device of claim 28 wherein the first device layer is adjacent to the second device layer.

32. The microfluidic device of claim 31 wherein the third device layer is adjacent to the second device layer.

33. A microfluidic device comprising:
a first device layer having a characteristic thickness;
a second device layer having a characteristic thickness;
a first channel segment defined through the entire thickness of the first device layer; and
a second channel segment defined through the entire thickness of the second device layer;
wherein the second channel is in fluid communication with the first channel segment to form a continuous flow path that defines a deformable circumscribed feature.

34. The microfluidic device of claim 33 wherein the first device layer and the second device layer each have a thickness between about twenty-five microns and about five hundred microns.

35. The microfluidic device of claim 33 wherein the first device layer is adjacent to the second device layer.

36. The microfluidic device of claim 33 wherein the first device layer and the second device layer are fabricated with polymeric materials.

37. The microfluidic device of claim 33 wherein the first device layer or the second device layer are fabricated with self-adhesive tape.

38. The microfluidic device of claim 33 wherein the circumscribed feature is completely surrounded by the continuous flow path.

39. The microfluidic device of claim 33, further comprising:
a third device layer having a characteristic thickness; and
a third channel segment defined through the entire thickness of the third device layer;
wherein the third channel segment is in fluid communication with the second channel segment and the third channel segment is included in the continuous flow path.

40. The microfluidic device of claim 39 wherein the first device layer, the second device layer and the third device layer each have a thickness between about twenty-five microns and about five hundred microns.

41. The microfluidic device of claim 37 wherein the second device layer is interposed between the first device layer and the third device layer and the first channel segment and the third channel segment cross at a crossover region.

42. The microfluidic device of claim 38 wherein the first device layer is adjacent to the second device layer.

43. The microfluidic device of claim 40 wherein the third device layer is adjacent to the second device layer.

44. The microfluidic device of claim 33, further comprising a third channel segment defined through the entire thickness of the first device layer, wherein the third channel segment is in fluid communication with the second channel segment and the third channel segment is included in the continuous flow path.

45. The microfluidic device of claim 44 wherein the first device layer and the second device layer each have a thickness between about twenty-five microns and about five hundred microns.

46. The microfluidic device of claim 44 wherein the first device layer is adjacent to the second device layer.

47. A microfluidic device for conducting a fluid, the device comprising:
a first device layer having a characteristic thickness;
a second device layer having a characteristic thickness;
a first channel segment defining a non-deformable circumscribed feature through the entire thickness of the first device layer;
a second channel segment defining a non-deformable circumscribed feature through the entire thickness of the second device layer; and
an overlap region permitting fluid communication between the first channel segment and the second channel segment;
wherein the first channel segment and the second channel segment define a deformable circumscribed feature having a feature length and an aspect ratio.

48. The microfluidic device of claim 47 wherein the first device layer and the second device layer each have a thickness between about twenty-five microns and about five hundred microns.

49. The microfluidic device of claim 48 wherein the feature length is greater than about six millimeters.

50. The microfluidic device of claim 49 wherein the aspect ratio is greater than about one.

51. The microfluidic device of claim 48 wherein the feature length is greater than about thirteen millimeters.

52. The microfluidic device of claim 51 wherein the aspect ratio is greater than about one.

53. The microfluidic device of claim 47 wherein the first device layer is adjacent to the second device layer.

54. The microfluidic device of claim 47 wherein the first device layer and the second device layer are fabricated with polymeric materials.

55. The microfluidic device of claim 47 wherein the first device layer or the second device layer are fabricated with self-adhesive tape.

56. A microfluidic device for conducting a fluid, the device comprising:
a first device layer having a characteristic thickness;
a second device layer having a characteristic thickness;
a third device layer having a characteristic thickness;
a first channel segment defining a non-deformable circumscribed feature through the entire thickness of the first device layer;
a second channel segment defining a non-deformable circumscribed feature through the entire thickness of the second device layer;
a third channel segment defining a non-deformable circumscribed feature through the entire thickness of the third device layer;
a first overlap region permitting fluid communication between the first channel segment and the second channel segment; and
a second overlap region permitting fluid communication between the second channel segment and the third channel segment;
wherein the first channel segment, the second channel segment, and the third channel segment define a deformable circumscribed feature having a feature length and an aspect ratio.

57. The microfluidic device of claim 56 wherein the first device layer, the second device layer, and the third device layer each have at thickness between about twenty-five microns and about five hundred microns.

58. The microfluidic device of claim 57 wherein the feature length is greater than about six millimeters.

59. The microfluidic device of claim 58 wherein the aspect ratio is greater than about one.

60. The microfluidic device of claim 57 wherein the feature length is greater than about thirteen millimeters.

61. The microfluidic device of claim 60 wherein the aspect ratio is greater than about one.

62. The microfluidic device of claim 56 wherein the first device layer is adjacent to the second device layer.

63. The microfluidic device of claim 62 wherein the third device layer is adjacent to the second device layer.

64. The microfluidic device of claim 56 wherein the first device layer, the second device layer, and the third device layer are fabricated with polymeric materials.

65. The microfluidic device of claim 56 wherein the any of the first device layer, the second device layer, or the third device layer are fabricated with self-adhesive tape.

66. A microfluidic device for conducting a fluid, the device comprising:
a first device layer having a characteristic thickness;
a second device layer having a characteristic thickness;
a first channel segment defining a non-deformable circumscribed feature through the entire thickness of the first device layer;
a second channel segment defining a non-deformable circumscribed feature through the entire thickness of the second device layer;
a third channel segment defining a non-deformable circumscribed feature through the entire thickness of the first device layer;
a first overlap region permitting fluid communication between the first channel segment and the second channel segment; and
a second overlap region permitting fluid communication between the second channel segment and the third channel segment; wherein the first channel segment, the second channel segment and the third channel segment define a deformable circumscribed feature having a feature length and an aspect ratio.

67. The microfluidic device of claim 66 wherein the first device layer and the second device layer each have a thickness between about twenty-five microns and about five hundred microns.

68. The microfluidic device of claim 66 wherein the feature length is greater than about six millimeters.

69. The microfluidic device of claim 68 wherein the aspect ratio is greater than about one.

70. The microfluidic device of claim 66 wherein the feature length is greater than about thirteen millimeters.

71. The microfluidic device of claim 70 wherein the aspect ratio is greater than about one.

72. The microfluidic device of claim 64 wherein the first device layer is adjacent to the second device layer.

73. The microfluidic device of claim 66 wherein the first device layer and the second device layer are fabricated with polymeric materials.

74. The microfluidic device of claim 66 wherein the first device layer or the second device layer are fabricated with self-adhesive tape.

75. A microfluidic device comprising:
a first device layer having a characteristic thickness;
a second device layer having a characteristic thickness;
a first plurality of channel segments defining a first plurality of non-deformable circumscribed features through the entire thickness of the first device layer; and
a second plurality of channel segments defining a second plurality of nondeformable circumscribed features through the entire thickness of the second device layer;
wherein the first plurality of channels are in fluid communication with the second plurality of channels to form at least one continuous flow path that defines at least one deformable circumscribed feature having a feature length and an aspect ratio.

76. The microfluidic device of claim 75 wherein the at least one continuous flow path defines a plurality of deformable circumscribed features.

77. The microfluidic device of claim 75 wherein the at least one continuous flow path defines a plurality of cumulative flow angle changes each greater than or equal to about ninety degrees.

78. The microfluidic device of claim 75 wherein the first device layer and second device layer each have a thickness between about twenty-five microns and about five hundred microns.

79. The microfluidic device of claim 78 wherein the feature length is greater than about six millimeters.

80. The microfluidic device of claim 79 wherein the aspect ratio is greater than about one.

81. The microfluidic device of claim 78 wherein the feature length is greater than about thirteen millimeters.

82. The microfluidic device of claim 81 wherein the aspect ratio is greater than about one.

83. The microfluidic device of claim 82 wherein the first device layer is adjacent to the second device layer.

84. The microfluidic device of claim 75 wherein the first device layer and the second device layer are fabricated with polymeric materials.

85. The microfluidic device of claim 75 wherein the first device layer or the second device layer are fabricated with self-adhesive tape.

86. A microfluidic device comprising:
a plurality of device layers each having a characteristic thickness; and
a plurality of channel segments each defining a non-deformable circumscribed feature through the entire thickness of at least one of the plurality of device layers;
wherein the each of the plurality of channel segments are in fluid communication at least one other of the plurality of channel segments to form at least one continuous flow path defining at least one deformable circumscribed feature having a feature length and an aspect ratio.

87. The microfluidic device of claim 86 wherein the continuous flow path defines a plurality of deformable circumscribed features.

88. The microfluidic device of claim 86 wherein the continuous flow path defines a plurality of cumulative flow angle changes each being greater than or equal to about ninety degrees.

89. The microfluidic device of claim 86 wherein each of the plurality of device layers comprises a polymeric material.

90. The microfluidic device of claim 86 wherein each of the plurality of device layers has a thickness between about twenty-five microns and about five hundred microns.

91. The microfluidic device of claim 90 wherein the feature length is greater than about six millimeters.

92. The microfluidic device of claim 91 wherein the aspect ratio is greater than about one.

93. The microfluidic device of claim 90 wherein the feature length is greater than about thirteen millimeters.

94. The microfluidic device of claim 93 wherein the aspect ratio is greater than about one.

95. A microfluidic device comprising:
a first device layer having a characteristic thickness;
a second device layer having a characteristic thickness;
a first channel segment defined through the entire thickness of the first device layer; and
a second channel segment defined through the entire thickness of the second device layer;
wherein the second channel is in fluid communication with the first channel segment to form a continuous flow path that defines a completely surrounded circumscribed feature.

96. The microfluidic device of claim 95, further comprising a third device layer interposed between the first device layer and the third device layer.

97. The microfluidic device of claim 96 wherein the first channel segment and the second channel segment cross at a crossover region.

98. The microfluidic device of claim 95 wherein the first device layer and the second device layer have a thickness between about twenty-five microns and about five hundred microns.

99. The microfluidic device of claim 95 wherein the plurality of device layers comprise polymeric materials.

100. The microfluidic device of claim 95 wherein any of the plurality of device layers are fabricated with self-adhesive tape.

101. A microfluidic device comprising:
a plurality of device layers each having a characteristic thickness; and
a plurality of channel segments each defining a non-deformable circumscribed feature through the entire thickness of at least one of the plurality of device layers;
wherein the each of the plurality of channel segments are in fluid communication at least one other of the plurality of channel segments to form at least one continuous flow path defining at least one completely surrounded circumscribed feature.

102. The microfluidic device of claim 101 wherein at least one of the plurality of channel segments crosses at least one other of the plurality if channel segments at a non-communicating channel crossing.

103. The microfluidic device of claim 101 wherein each of the plurality of device layers has substantially the same thickness.

104. The microfluidic device of claim 101 wherein each of the plurality of device layers has a thickness between about twenty-five microns and about five hundred microns.

105. The microfluidic device of claim 101 wherein each layer of the plurality of device layers are fabricated with polymeric materials.

106. The microfluidic device of claim 101 wherein any layer of the plurality of device layers is fabricated with self-adhesive tape.
